(19) United States
(12) Patent Application Publication
(10) Pub. No.: US 2026/0339698 A1
(43) Pub. Date: Oct. 29, 2026

(54) INFORMATION PROCESSING APPARATUS

(71) Applicant: NEC Corporation, Tokyo (JP)

(72) Inventors: Kunihiro TAKEOKA, Tokyo (JP); Masafumi ENOMOTO, Tokyo (JP)

(73) Assignee: NEC Corporation, Tokyo (JP)

(21) Appl. No.: 19/648,055

(22) Filed: Apr. 15, 2026

(30) Foreign Application Priority Data
Apr. 28, 2025 (JP) 2025-074443

(51) Int. Cl. G06F 9/48; G06F 16/903

(52) U.S. Cl. CPC G06F 9/4843; G06F 16/90335

(57) ABSTRACT

An information processing apparatus includes an accepting unit that accepts a query that instructs execution of a task, a confirmation information generating unit that generates, in response to the query, confirmation information listing states of a deliverable that is generable by executing the task instructed by the query, and a presenting unit that presents the confirmation information.

### INCORPORATION BY REFERENCE

This application is based upon and claims the benefit of priority from Japanese patent application No. 2025-074443, filed on Apr. 28, 2025, the disclosure of which is incorporated herein in its entirety by reference.

### TECHNICAL FIELD

The present invention relates to an information processing apparatus, an information processing method, and a storage medium.

### BACKGROUND ART

A technology used for processing a request from a user using a large language model (LLM) or the like has been known.

As related art, Patent Literature 1 has been known, for example. Patent Literature 1 discloses that when a goal seek prompt 70 is input to an LLM, a question (sentence) is returned to guide the user to the goal. According to Patent Literature 1, returned questions and the answers from the user are repeated until the user's goal is finally achieved. This allows the user to efficiently move toward the goal without having to think about the prompt each time.

Patent Literature 1: JP 7615515 B

### SUMMARY

In the case of the technology described in Patent Literature 1, questions are repeatedly given to the user until the goal is achieved. As a result, multiple interactions between the user and the system occur before execution of a specific task, causing a problem that it may be difficult to suppress an increase in the communication costs for the user.

Therefore, an example object of the present disclosure is to provide an information processing apparatus, an information processing method, and a program that can solve the aforementioned problem.

In order to achieve such an example object, an information processing apparatus according to the present disclosure is configured to include
an accepting unit that accepts a query that instructs execution of a task,
a confirmation information generating unit that, in response to the query, generates confirmation information listing states of a deliverable that is generable by executing the task instructed by the query, and
a presenting unit that presents the confirmation information.

Further, an information processing method according to the present disclosure is configured to include, by an information processing apparatus,
accepting a query that instructs execution of a task,
in response to the query, generating confirmation information listing states of a deliverable that is generable by executing the task instructed by the query, and
presenting the confirmation information.

Further, a storage medium according to the present disclosure is a computer-readable storage medium storing thereon a program for causing an information processing apparatus to execute processing to
accept a query that instructs execution of a task,
in response to the query, generate confirmation information listing states of a deliverable that is generable by executing the task instructed by the query, and
present the confirmation information.

According to the above-described configurations, it is possible to suppress an increase in the communication costs for users.

### BRIEF DESCRIPTION OF DRAWINGS

FIG. 1 is a diagram illustrating an overview of a task execution system;

FIG. 2 is a block diagram illustrating an example configuration of a task execution apparatus;

FIG. 3 is a diagram illustrating an example of confirmation information;

FIG. 4 is a diagram illustrating an example output from an output unit;

FIG. 5 is a flowchart illustrating an example of operation of the task execution apparatus;

FIG. 6 is a block diagram illustrating an example of a hardware configuration of an information processing apparatus;

FIG. 7 is a block diagram illustrating an example configuration of an information processing apparatus;

FIG. 8 is a flowchart illustrating an example of operation of the information processing apparatus; and

FIG. 9 is a diagram illustrating an example of an agent communication environment using A2A protocol.

### EXAMPLE EMBODIMENTS

### First Example Embodiment

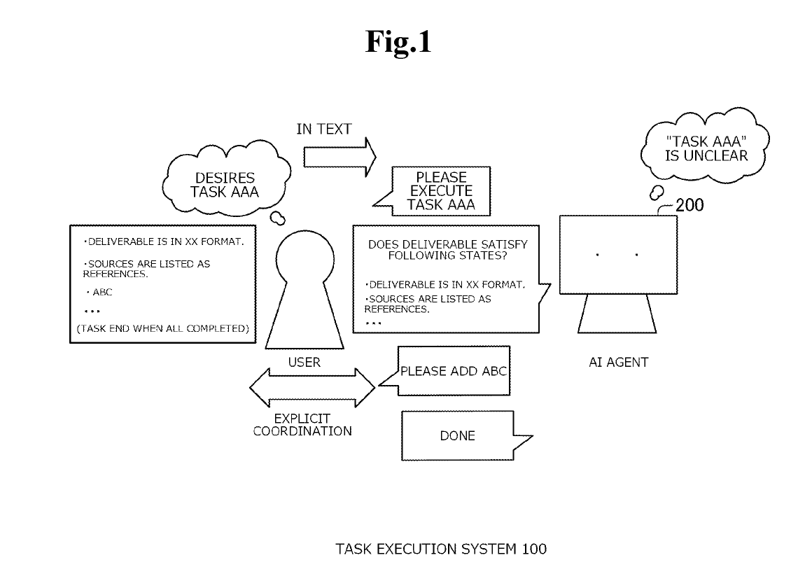

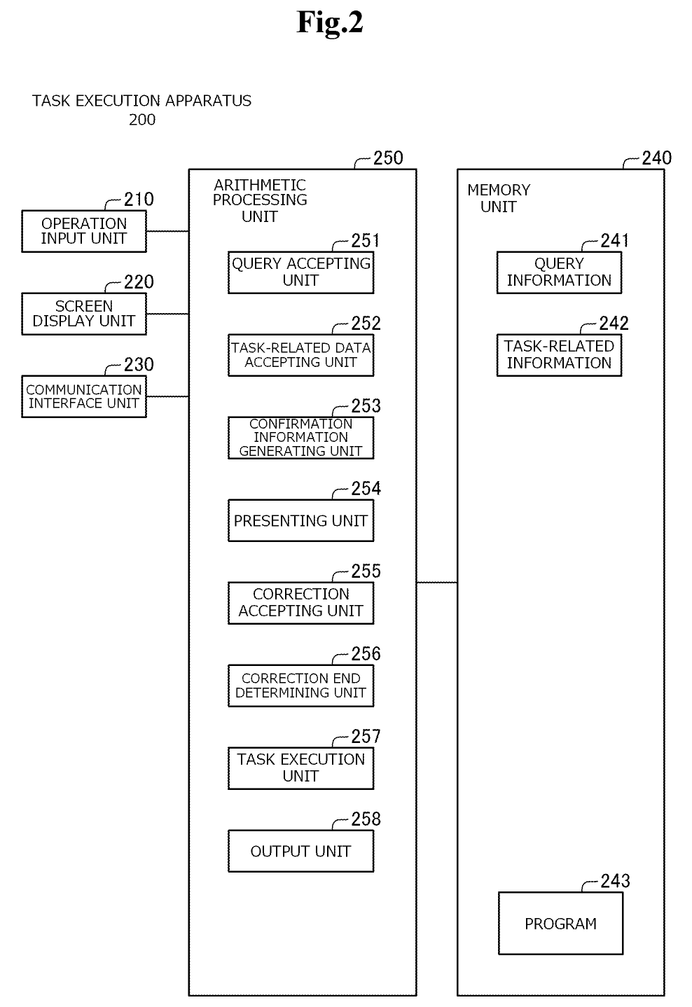

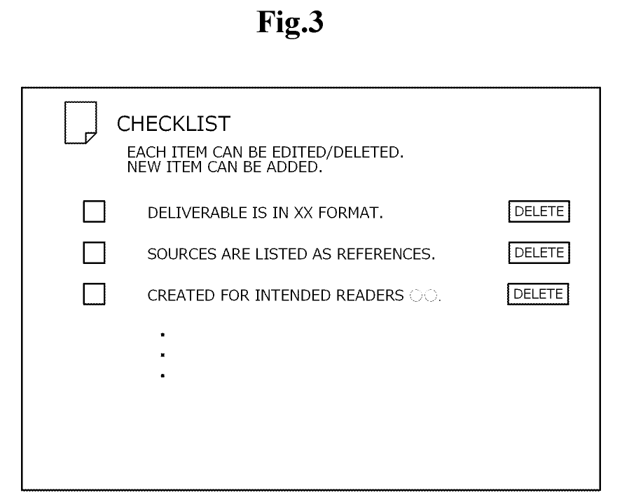

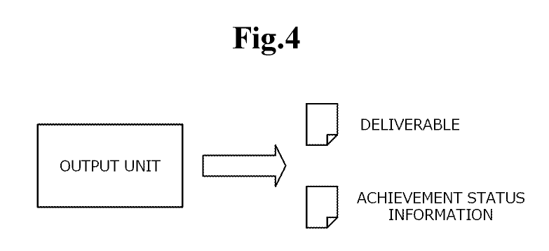

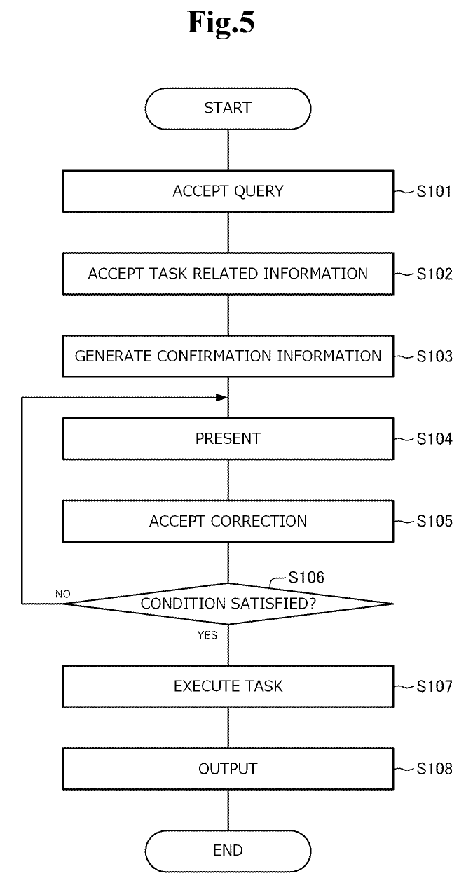

An example configuration of a task execution system 100 according to the present disclosure will be described with reference to FIGS. 1 - 5. FIG. 1 is a diagram illustrating an overview of the task execution system 100. FIG. 2 is a block diagram illustrating an example configuration of a task execution apparatus 200. FIG. 3 is a diagram illustrating an example of confirmation information. FIG. 4 is a diagram illustrating an example output from an output unit 258. FIG. 5 is a flowchart illustrating an example of operation of the task execution apparatus 200. In the present disclosure, the drawings may be associated with one or a plurality of example embodiments.

In present disclosure, the task execution system 100 will be described in which the task execution device 200 functioning as an AI (Artificial Intelligence) agent or the like executes a task corresponding to an instruction from a user. FIG. 1 illustrates an overview of the task execution system 100. As illustrated in FIG. 1, when the task execution apparatus 200 accepts a query that is an instruction from a user, it generates confirmation information listing the states of a deliverable that can be generated by executing a task corresponding to the instruction. For example, the task execution apparatus 200 generates, as confirmation information, checklist information consisting of a checklist showing the states of a deliverable in a list using a plurality of items. The task execution apparatus 200 may generate confirmation information by inputting a query that is an instruction from a user or a task indicated by the query into a trained model such as an LLM (Large Language Model). Thereafter, the task execution apparatus 200 presents the generated confirmation information to the user. This allows the user to check the states of a deliverable at once before the task execution apparatus 200 actually executes the task. For example, in the case illustrated in FIG. 1, the user is able to confirm that the states of the deliverable lacks an "ABC" state before actually executing the task.

Furthermore, the task execution apparatus 200 is able to accept corrections to the presented confirmation information through operations or the like by the user. For example, in the case of FIG. 1, the task execution apparatus 200 accepts a correction to add "ABC" to the confirmation information. The task execution apparatus 200 then executes a task corresponding to the instruction using the instruction from the user and the confirmation information corrected as necessary. For example, with this configuration, the task execution apparatus 200 is able to execute the task after coordinating, with the user, the states of the deliverable without incurring communication costs.

For example, when a user gives an instruction to the task execution apparatus 200 using a query or the like, there is a risk that a deliverable generated by the task execution apparatus 200 when executing the task will not be what the user desires, due to insufficient contents of the instruction. According to the above-described configuration, such a risk can be reduced by coordinating the states of the deliverable in advance. Furthermore, according to the above-described configuration, confirmation information such as checklist information is presented to the user, which allows coordination regarding the states of the deliverable. As a result, necessary corrections and the like can be accepted all at once, and the possibility of multiple interactions with the user can be reduced.

In the present disclosure, an AI agent refers to an entity that executes a task using an instruction from a user as an input. An AI agent can use a variety of tools to perform a task while interacting with the environment. For example, an AI agent may consist of a trained model such as an LLM, or a trained model such as an LLM and one or a plurality of tools. The tools may include at least some of a search engine, an email and calendar, programming that performs predetermined processing such as addition, and any other programs. The AI agent may be configured to use only available tools from among a plurality of tools. Whether or not a tool is available may be designated by a query or by any other means.

In the present disclosure, there are no particular limitations on users. For example, a user may be a person who operates the task execution apparatus 200. A user may be another AI agent configured of another task execution apparatus 200 or the like.

FIG. 2 illustrates an example of the main configuration of the task execution apparatus 200 that is an information processing apparatus constituting an AI agent. Referring to FIG. 2, the task execution apparatus 200 includes, as its main components, an operation input unit 210, a screen display unit 220, a communication interface unit 230, a memory unit 240, and an arithmetic processing unit 250.

FIG. 2 illustrates an example in which the functions as the task execution apparatus 200 are realized using one information processing apparatus. However, at least some of the functions as the task execution apparatus 200 may be implemented using multiple information processing apparatuses, for example, on the cloud. Furthermore, the task execution apparatus 200 may not include some of the components exemplified above, such as not having the operation input unit 210 or the screen display unit 220, or may have a component other than those exemplified above.

The operation input unit 210 is configured of operation input devices such as a keyboard and a mouse. The operation input unit 210 detects an operation of a user operating the task execution apparatus 200 and outputs the operation to the arithmetic processing unit 250.

The screen display unit 220 is configured of a screen display device such as a liquid crystal display or an organic electro-luminescence (EL) display. The screen display unit 220 can display various types of information stored in the memory unit 240 on the screen, in response to instructions from the arithmetic processing unit 250.

The communication interface unit 230 is configured of a data communication circuit and the like. The communication interface unit 230 performs data communication with an external device connected via a communication line.

The memory unit 240 includes storage devices such as a hard disk and a memory. The memory unit 240 stores processing information and programs 243 required for various types of processing performed in the arithmetic processing unit 250. The program 243 is read into the arithmetic processing unit 250 and executed to realize various processing units. The program 243 is read in advance from an external device or a storage medium via a data input/output function such as the communication interface unit 230 and is stored in the memory unit 240. The main information stored in the memory unit 240 includes, for example, query information 241, task-related information 242, and the like.

The query information 241 includes a query that is an instruction from a user. The query included in the query information 241 may include the contents of a task that is instructed to be executed by the task execution apparatus 200, and the like. The query information 241 can be updated when the query accepting unit 251 accepts a query from a user.

The task-related information 242 includes information supplementing the contents of the task and information required when executing the task. For example, the task-related information 242 may include rules that the task execution apparatus 200 must follow when executing the task. The task-related information 242 can be updated by a task-related data accepting unit 252 accepting task-related data indicating the aforementioned rules and the like.

The arithmetic processing unit 250 includes an arithmetic logic unit such as a CPU (Central Processing Unit) and its peripheral circuits. The arithmetic processing unit 250 reads and executes the program 243 from the memory unit 240, thereby causing the above hardware and the program 243 to cooperate to realize various processing units. The main processing units realized by the arithmetic processing unit 250 include, for example, a query accepting unit 251, a task-related data accepting unit 252, a confirmation information generating unit 253, a presenting unit 254, a correction accepting unit 255, a correction end determining unit 256, a task execution unit 257, and an output unit 258.

In addition, the arithmetic processing unit 250 may have a GPU (Graphics Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof, instead of the aforementioned CPU.

The query accepting unit 251 accepts a query that is an instruction from a user. For example, the query accepting unit 251 may accept a query that instructs the content of a task to be executed by accepting input of information using the operation input unit 210, by accepting input of information from an external device via the communication interface unit 230, or the like. The query accepting unit 251 is able to store the accepted query in the query information 241.

The task-related data accepting unit 252 accepts task-related data. For example, the task-related data accepting unit 252 may accept task-related data from a user by accepting input of information using the operation input unit 210, by accepting input of information from an external device via the communication interface unit 230, or the like. Furthermore, the task-related data accepting unit 252 is able to store the accepted task-related data in the memory unit 240 as the task-related information 242.

Note that the task-related data accepting unit 252 may accept the task-related data at a timing different from the timing of accepting a query by the query accepting unit 251. Furthermore, in the case where there is no task-related data for example, the task-related data accepting unit 252 may omit acceptance of the task-related data.

The confirmation information generating unit 253 generates confirmation information indicating the states of a deliverable that can be generated by execution of a task corresponding to the accepted query. For example, the confirmation information generating unit 253 generates confirmation information by inputting the accepted query into a trained model such as an LLM. The confirmation information generating unit 253 may input a task or the like to the trained model instead of a query. In addition, the confirmation information generating unit 253 may input task-related data to the trained model along with a query or the like.

FIG. 3 illustrates an example of the confirmation information generated by the confirmation information generating unit 253. Referring to FIG. 3, the confirmation information generating unit 253 is able to generate, as confirmation information, checklist information including a checklist showing the states of a deliverable in a list using a plurality of items. For example, referring to FIG. 3, the confirmation information includes one or a plurality of items indicating the states of the deliverable, such as "Deliverable is in XX format", "Sources are listed as references", "Created for intended readers YY", "Title is ZZ", and "It has an appropriate amount and contains necessary information".

FIG. 3 illustrates the confirmation information in which a checkbox corresponding to each item is generated. However, the confirmation information may include a slider bar that allows a range to be designated or any other elements, besides a checkbox. The elements such as a checkbox included in the confirmation information may be adjusted as appropriate depending on the contents of the items. The number of items included in the confirmation information generated by the confirmation information generating unit 253 may be designated in advance by the user or the like. For example, the user can designate in advance the upper limit value of the items included in the confirmation information with use of a query, task-related data, or any other means.

Furthermore, the states of the deliverable indicated by the confirmation information may be other than the above-described examples. In other words, the confirmation information may include any information indicating the states of the deliverable other than the examples described above. For example, in addition to the information exemplified above, as information indicating the states of the deliverable, the confirmation information may include, for example, information indicating any constraints at intermediate steps when generating the deliverable. For example, as information indicating the states of the deliverable that can be determined from the deliverable, the confirmation information may include information indicating any constraints at intermediate processing when generating the deliverable, such as "The deliverable was created after searching for documents of xx company", "The deliverable was created by processing using yy tool", or the like. The confirmation information generating unit 253 may be configured to generate the above-described confirmation information after confirming the tools that are permitted by the query or the like among the tools held by the task execution system 100.

The presenting unit 254 presents the confirmation information generated by the confirmation information generating unit 253 to the user. At this time, the presenting unit 254 is able to present the confirmation information in a state where each item can be deleted or edited, by adding a delete button to each item as illustrated in FIG. 3. Furthermore, the presenting unit 254 may present the confirmation information so that an item can be added if necessary. For example, the presenting unit 254 may present the confirmation information by displaying the generated confirmation information on the screen display unit 220, by transmitting the confirmation information to a specific external device via the communication interface unit 230, or the like.

The correction accepting unit 255 accepts predetermined correction processing with respect to the confirmation information presented by the presenting unit 254. For example, the correction accepting unit 255 is able to accept correction processing that includes at least part of deletion, edition, and addition of items. The correction accepting unit 255 may perform correction processing by accepting an operation performed on the operation input unit 210, accepting an input via the communication interface unit 230, or the like.

The correction end determining unit 256 determines whether or not to end acceptance of correction processing. The correction end determining unit 256 may make the above determination by checking whether or not a predetermined condition is satisfied.

For example, the correction end determining unit 256 determines to end acceptance of correction processing by acquiring, from the user, information indicating that no correction will be made. The correction end determining unit 256 may also determine whether or not to end acceptance of correction processing by checking the content of the correction processing accepted by the correction accepting unit 255. For example, the correction end determining unit 256 is able to determine to end acceptance of correction processing by checking the amount of correction added and corrected by editing or adding an item. As an example, the correction end determining unit 256 may determine to end acceptance of correction processing when the amount of correction is equal to or less than a predetermined threshold. Furthermore, the correction end determining unit 256 generates new confirmation information that reflects the accepted correction processing. Then, the correction end determining unit 256 may determine whether or not to end acceptance of correction processing by checking the status of the newly generated confirmation information. For example, the correction end determining unit 256 may determine to end acceptance of correction processing when, for example, it can determine that no item that requires user confirmation has been added to the newly generated confirmation information. Note that the correction end determining unit 256 may use any algorithm other than the one exemplified above to determine whether or not to end acceptance of correction processing. For example, the correction end determining unit 256 is able to determine to end acceptance of correction processing when it is confirmed using any method that the content of the accepted correction process is not unclear.

When the correction end determining unit 256 determines not to end acceptance of correction processing, the presenting unit 254 may present the generated new confirmation information to the user.

The task execution unit 257 executes the task corresponding to the query. For example, the task execution unit 257 is able to execute the task after the correction end determining unit 256 determines to end acceptance of correction processing.

For example, the task execution unit 257 executes the task using the confirmation information and the query to thereby generate a deliverable. As an example, the task execution unit 257 inputs a query and confirmation information to a trained model such as an LLM. At that time, the task execution unit 257 may input information indicating a task or the like, instead of a query, to the trained model. Furthermore, the task execution unit 257 may input task-related data to the trained model together with the query or the like. The trained model having accepted an input such as a query executes the corresponding task. For example, the trained model executes the task so as to meet the states of the deliverable indicated by the confirmation information as much as possible. As described above, the trained model may use a predetermined tool or the like for executing a task. Thereafter, as a result of task execution using the trained model, the task execution unit 257 acquires a deliverable.

The trained model may output, together with the deliverable, achievement status information that is information indicating the states having actually been reflected in the generated deliverable, among the states of the deliverable indicated by the confirmation information. For example, the trained model may output achievement status information in which items corresponding to the states reflected on the generated deliverable, among the pieces of information as illustrated in FIG. 3, are checked. The achievement status information may be generated by the task execution unit 257 or the like instead of the trained model.

The output unit 258 outputs the deliverable acquired by the task execution unit 257. As illustrated in FIG. 4, the output unit 258 may output achievement status information and the like together with the deliverable. For example, the output unit 258 is able to display the deliverable and the like on the screen display unit 220 or transmit them to an external device via the communication interface unit 230.

The above is an example configuration of the task execution apparatus 200. The LLM used by the confirmation information generating unit 253 when generating confirmation information and the LLM used by the task execution unit 257 when executing a task may be the same or different. Next, an example of operation of the task execution apparatus 200 will be described with reference to FIG. 5.

FIG. 5 is a flowchart illustrating an example of operation of the task execution apparatus 200. Referring to FIG. 5, the query accepting unit 251 accepts a query that is an instruction from a user (step S101), and the task-related data accepting unit 252 accepts task-related data (step S102).

The confirmation information generating unit 253 generates confirmation information indicating the states of a deliverable that can be generated by execution of the task corresponding to the accepted query (step S103). For example, the confirmation information generating unit 253 generates confirmation information by inputting the accepted query into a trained model such as an LLM.

The presenting unit 254 presents the confirmation information generated by the confirmation information generating unit 253 to the user (step S104).

The correction accepting unit 255 accepts predetermined correction processing with respect to the confirmation information presented by the presenting unit 254 (step S105).

The correction end determining unit 256 determines whether or not to end acceptance of correction processing by checking whether or not a predetermined condition is satisfied (step S106). When the predetermined condition is not satisfied (NO in step S106), the processing returns to step S104 and the presenting unit 254 presents confirmation information. The confirmation information may be generated again before the processing of step S104.

On the contrary, when the condition is satisfied (YES at step S106), the task execution unit 257 executes the task (step S107). For example, the task execution unit 257 may execute the task using the query and the confirmation information.

The output unit 258 outputs a deliverable generated as a result of executing the task (step S108). The output unit 258 may output the deliverable and achievement status information.

The above is an example of operation of the task execution apparatus 200. It should be noted that FIG. 5 illustrates an example of operation of the task execution apparatus 200, and the operation of the task execution apparatus 200 is not limited to the example illustrated in FIG. 5. For example, the processing of step S102 may be performed in advance or may be omitted.

As described above, the task execution system 100 includes the confirmation information generating unit 253 and the presenting unit 254. With this configuration, the presenting unit 254 is able to present the confirmation information generated by the confirmation information generating unit 253 to the user. As a result, the states of the deliverable can be coordinated in advance. This can reduce the risk of generating a deliverable that is not what the user desires. Furthermore, necessary corrections and the like can be accepted all at once, which reduces the risk of multiple interactions between the user and the system. In other words, the above configuration can suppress an increase in the communication costs.

### Second Example Embodiment

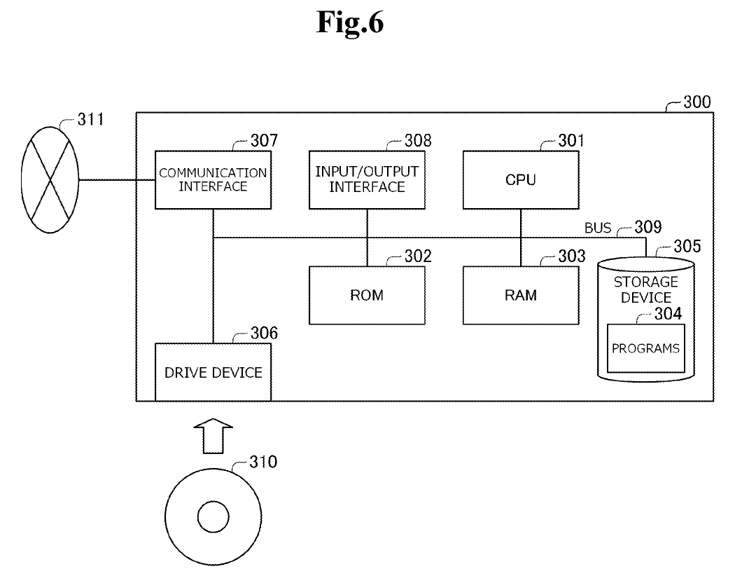

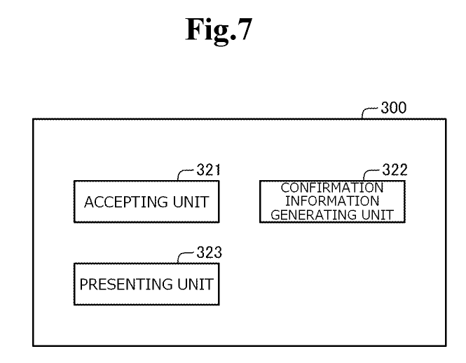

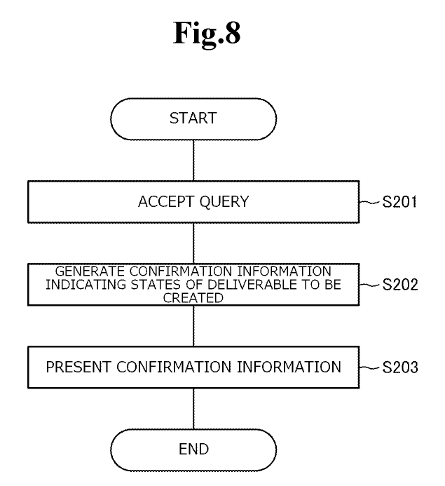

Next, an information processing apparatus 300 that is a modified example of the task execution apparatus 200 will be described with reference to FIGS. 6 - 8. FIG. 6 is a diagram illustrating an example of a hardware configuration of the information processing apparatus 300. FIG. 7 is a block diagram illustrating an example configuration of the information processing apparatus 300. FIG. 8 is a flowchart illustrating an example of operation of the information processing apparatus 300.

The information processing apparatus 300 is an information processing apparatus that executes a task instructed by a query. FIG. 6 illustrates an example of a hardware configuration of the information processing apparatus 300. Referring to FIG. 6, the information processing apparatus 300 has the following hardware configuration, for example:
a CPU (Central Processing Unit) 301 (arithmetic logic unit);
a ROM (Read Only Memory) 302 (memory unit);
a RAM (Random Access Memory) 303 (memory unit);
programs 304 loaded into the RAM 303;
a storage device 305 that stores the programs 304;
a drive device 306 that performs reading from and writing into a storage medium 310 external to the information processing apparatus 300;
a communication interface 307 connected to a communication network 311 external to the information processing apparatus 300;
an input/output interface 308 for inputting and outputting data; and
a bus 309 connecting the components.

The information processing apparatus 300 is able to realize the functions of an accepting unit 321, a confirmation information generating unit 322, and a presenting unit 323 illustrated in FIG. 7 by the CPU 301 acquiring and executing the programs 304. The programs 304 are stored in advance in the storage device 305 or the ROM 302, for example, and are loaded into the RAM 303 or the like by the CPU 301 for execution as needed. The programs 304 may be supplied to the CPU 301 via the communication network 311, or may be stored in advance on the storage medium 310, and the drive device 306 may read out the programs and supply them to the CPU 301.

FIG. 6 illustrates an example of a hardware configuration of the information processing apparatus 300. The hardware configuration of the information processing apparatus 300 is not limited to the above-described case. For example, the information processing apparatus 300 may be configured of only a part of the above-described configuration, such as excluding the drive device 306. Furthermore, the CPU 301 may be a GPU exemplified in the first example embodiment.

The accepting unit 321 accepts a query that instructs execution of a task. The accepting unit may accept a query using any means.

In response to the query, the confirmation information generating unit 322 generates confirmation information listing the states of a deliverable that can be generated by execution of the task instructed by the query. For example, the confirmation information generating unit 322 may generate confirmation information by inputting a query or the like into a trained model such as an LLM.

The presenting unit 323 presents the confirmation information.

The above is an example configuration of the information processing apparatus 300. Next, an example of operation of the information processing apparatus 300 will be described with reference to FIG. 8.

FIG. 8 is a flowchart illustrating an example of operation of the information processing apparatus 300. Referring to FIG. 8, the accepting unit 321 accepts a query that instructs execution of a task (step S201).

In response to the query, the confirmation information generating unit 322 generates confirmation information listing the states of a deliverable that can be generated by execution of the task instructed by the query (step S202).

The presenting unit 323 presents the confirmation information (step S203).

The above is an example of operation of the information processing apparatus 300.

As described above, the information processing apparatus 300 includes the confirmation information generating unit 322 and the presenting unit 323. With this configuration, the presenting unit 323 is able to present the confirmation information generated by the confirmation information generating unit 322. As a result, the user is able to check information indicating the states of the deliverable at once. This allows necessary corrections to be made all at once, reducing the need for repeated interactions with the user. In other words, the above configuration enables suppression of an increase in the communication costs.

The information processing apparatus 300 described above can be realized by installing a predetermined program in an apparatus such as the information processing apparatus 300. Specifically, a program that is another aspect of the present disclosure is a program for causing an apparatus such as the information processing apparatus 300 to execute processing to accept a query that instructs execution of a task, in response to the query, generate confirmation information listing the states of a deliverable that can be generated by execution of the task instructed by the query, and present the confirmation information.

Furthermore, an information processing method executed by an apparatus such as the information processing apparatus 300 described above is a method including, by the apparatus such as the information processing apparatus 300, accepting a query that instructs execution of a task, in response to the query, generating confirmation information listing the states of a deliverable that can be generated by execution of the task instructed by the query, and presenting the confirmation information.

Even in the case of a program, a computer-readable storage medium storing a program thereon, or an information processing method having the above-described configuration, it is possible to achieve the same actions and effects as those of the above-described information processing apparatus 300, and therefore can achieve the above-described example object of the present disclosure.

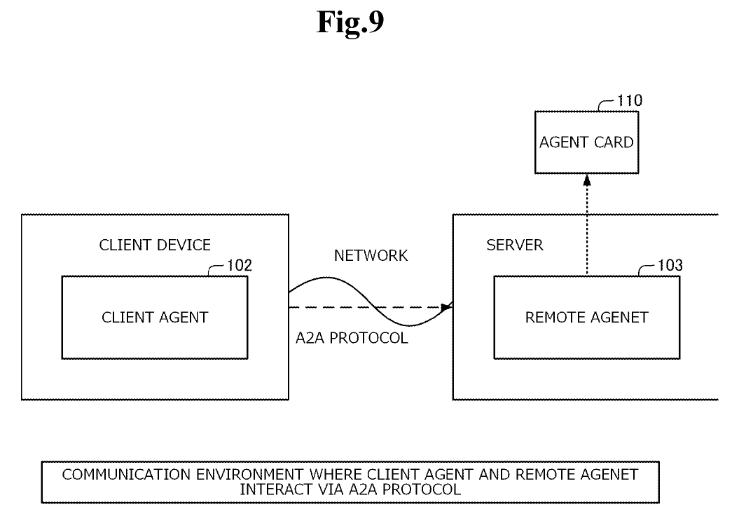

It should be noted that the information processing apparatus of the present disclosure (e.g., the task execution apparatus 200 or the information processing apparatus 300) can be used not only to process queries from the user alone, but also as a component that cooperates with other AI agents in a broader ecosystem. An example of a protocol that realizes such cooperation is Agent-to-Agent Communication Protocol (A2A protocol). FIG. 9 illustrates an example of an agent communication environment using the A2A protocol, in which a client agent 102 and a remote agent 103 communicate and cooperate with each other to execute tasks according to a protocol that specifies capability discovery using an agent card 110, standardized message formats (TextPart, FilePart, etc.), task status management (submitted, working, input-required, completed, etc.), and the like. When the information processing apparatus disclosed herein is implemented as the client agent 102 or the remote agent 103 in such an A2A protocol environment, the confirmation information generating unit (253, 322) and the presenting unit (254, 323) function as means for efficiently confirming in advance, and coordinating, the final deliverable of a collaboration task and the status at an intermediate stage of the collaboration between the user and the other agents, and are expected to contribute to reducing the communication costs throughout the system and preventing rework.

### Supplementary Notes

The whole or part of the example embodiments disclosed above can be described as the following supplementary notes. An overview of an information processing apparatus and the like according to the present disclosure will be described below. However, the present disclosure is not limited to the following configuration.

### Supplementary Note 1

An information processing apparatus comprising:
an accepting unit that accepts a query that instructs execution of a task;
a confirmation information generating unit that, in response to the query, generates confirmation information listing states of a deliverable that is generable by executing the task instructed by the query; and
a presenting unit that presents the confirmation information.

### Supplementary Note 2

The information processing apparatus according to supplementary note 1, wherein the confirmation information generating unit generates the confirmation information indicating the states of the deliverable that is generable by executing the task by an artificial intelligence (AI) agent, in response to the query.

### Supplementary Note 3

The information processing apparatus according to supplementary note 1 or 2, wherein as the confirmation information, the confirmation information generating unite generates checklist information listing the states of the deliverable using a plurality of items.

### Supplementary Note 4

The information processing apparatus according to any one of supplementary notes 1 to 3, further comprising
a task execution unit that executes the task instructed by the query to generate the deliverable using the confirmation information and the query.

### Supplementary Note 5

The information processing apparatus according to supplementary note 4, further comprising
an output unit that outputs the deliverable generated by the task execution unit, wherein
the output unit outputs information indicating a state reflected in the generated deliverable among the states indicated by the confirmation information, along with the deliverable.

### Supplementary Note 6

The information processing apparatus according to any one of supplementary notes 1 to 5, further comprising:
a correction accepting unit that accepts a correction with respect to the presented confirmation information; and
a correction end determining unit that determines whether or not to end acceptance of a correction depending on a content of the correction accepted by the correction accepting unit.

### Supplementary Note 7

The information processing apparatus according to supplementary note 6, further comprising
a task execution unit that executes the task instructed by the query to generate the deliverable, using the confirmation information and the query, wherein
after the correction end determining unit determines to end acceptance of a correction, the task execution unit executes the task instructed by the query to generate the deliverable, using the confirmation information and the query.

### Supplementary Note 8

The information processing apparatus according to any one of supplementary notes 1 to 7, wherein
in response to the query, the confirmation information generating unit generates the configuration information including information that indicates the states of the deliverable that is generable by executing the task instructed by the query and indicates a constraint on intermediate processing when generating the deliverable.

### Supplementary Note 9

An information processing method comprising, by an information processing apparatus:
accepting a query that instructs execution of a task;
in response to the query, generating confirmation information listing states of a deliverable that is generable by executing the task instructed by the query; and
presenting the confirmation information.

### Supplementary Note 10

A program for causing an information processing apparatus to execute processing to:
accept a query that instructs execution of a task;
in response to the query, generate confirmation information listing states of a deliverable that is generable by executing the task instructed by the query; and
present the confirmation information.

Note that some or all of the configurations described in Supplementary Notes 2 to 8 that are dependent on the information processing apparatus described in Supplementary Note 1 may also be dependent in a similar dependent relationship on the information processing method described in Supplementary Note 9, the program described in Supplementary Note 10, and the like. Furthermore, not limited to Supplementary Notes 9 and 10, some or all of the configurations described as supplementary notes may also be dependent with respect to various hardware, software, and various storage means for storing software, methods, or programs within the scope of each of the above-described example embodiments.

Furthermore, the programs described in the above example embodiments and supplementary notes can be stored in and supplied to a computer using various types of non-transitory computer-readable media. The non-transitory computer-readable media include various types of tangible storage media. Examples of non-transitory computer-readable media include magnetic recording media (e.g., flexible disks, magnetic tapes, hard disk drives), magneto-optical recording media (e.g., magneto-optical disks), CD-ROMs (Read Only Memories), CD-Rs, CD-R/Ws, and semiconductor memories (e.g., mask ROMs, PROMs (Programmable ROMs), EPROMs (Erasable PROMs), flash ROMs, and RAMs (Random Access Memories)). In addition, the programs may be provided to a computer by various types of transitory computer-readable media. Examples of transitory computer-readable media include electrical signals, optical signals, and electromagnetic waves. The transitory computer-readable media may provide a program to the computer via a wired communication channel such as an electric wire or an optical fiber, or a wireless communication channel.

Although the present disclosure has been described above with reference to the above-described example embodiments, the present disclosure is not limited to the above-described example embodiments. The configurations and details of the present disclosure can be changed in a variety of ways that those skilled in the art can understand within the scope of the present disclosure. Each embodiment can be combined with other embodiments as appropriate.

### REFERENCE SIGNS LIST

100 task execution system
200 task execution apparatus
210 operation input unit
220 screen display unit
230 communication interface unit
240 memory unit
241 query information
242 task-related information
243 program
250 arithmetic processing unit
251 query accepting unit
252 task-related data accepting unit
253 confirmation information generating unit
254 presenting unit
255 correction accepting unit
256 correction end determining unit
257 task execution unit
258 output unit
300 information processing apparatus
301 CPU
302 ROM
303 RAM
304 programs
305 storage device
306 drive device
307 communication interface
308 input/output interface
309 bus
310 storage medium
311 communication network
321 accepting unit
322 confirmation information generating unit
323 presenting unit
102 client agent
103 remote agent
110 agent card

1. An information processing apparatus comprising:
at least one memory configured to store instructions; and
at least one processor configured to execute the instructions to:
accept a query that instructs execution of a task;
in response to the query, generate confirmation information listing states of a deliverable that is generable by executing the task instructed by the query; and
present the confirmation information.

2. The information processing apparatus according to claim 1, wherein the at least one processor is configured to execute the instructions to
generate the confirmation information indicating the states of the deliverable that is generable by executing the task by an artificial intelligence (AI) agent, in response to the query.

3. The information processing apparatus according to claim 1, wherein the at least one processor is configured to execute the instructions to,
as the confirmation information, generate checklist information listing the states of the deliverable using a plurality of items.

4. The information processing apparatus according to claim 1, wherein the at least one processor is configured to execute the instructions to
execute the task instructed by the query to generate the deliverable, using the confirmation information and the query.

5. The information processing apparatus according to claim 4, wherein the at least one processor is configured to execute the instructions to:
output the generated deliverable, and
output information indicating a state reflected in the generated deliverable among the states indicated by the confirmation information, along with the deliverable.

6. The information processing apparatus according to claim 1, wherein the at least one processor is configured to execute the instructions to:
accept a correction with respect to the presented confirmation information; and
determine whether or not to end acceptance of a correction depending on a content of the accepted correction.

7. The information processing apparatus according to claim 6, wherein the at least one processor is configured to execute the instructions to:
execute the task instructed by the query to generate the deliverable, using the confirmation information and the query; and
after determining to end acceptance of a correction, execute the task instructed by the query to generate the deliverable, using the confirmation information and the query.

8. The information processing apparatus according to claim 1, wherein the at least one processor is configured to execute the instructions to,
in response to the query, generate the confirmation information including information that indicates the states of the deliverable that is generable by executing the task instructed by the query and indicates a constraint on intermediate processing when generating the deliverable.

9. An information processing method comprising, by an information processing apparatus:
accepting a query that instructs execution of a task;
in response to the query, generating confirmation information listing states of a deliverable that is generable by executing the task instructed by the query; and
presenting the confirmation information.

10. A non-transitory computer-readable medium storing thereon a program comprising instructions for causing an information processing apparatus to execute processing to:
accept a query that instructs execution of a task;
in response to the query, generate confirmation information listing states of a deliverable that is generable by executing the task instructed by the query; and
present the confirmation information.
